(19) United States
(12) Patent Application Publication
(10) Pub. No.: US 2019/0366920 A1
(43) Pub. Date: Dec. 5, 2019

(54) HEAVY EQUIPMENT SAFETY COMMUNICATION SYSTEMS AND METHODS

(71) Applicant: Timothy Klenck, Evansville, IN (US)

(72) Inventor: Timothy Klenck, Evansville, IN (US)

(21) Appl. No.: 16/484,943

(22) PCT Filed: Feb. 9, 2018
(86) PCT No.: PCT/US2018/017609

§ 371 Date: Aug. 9, 2019

Related U.S. Application Data
(60) Provisional application No. 62/457,484, filed on Feb. 10, 2017.

(51) Int. Cl. B60Q 5/00; G05B 9/02; G06Q 50/26; G07C 5/02; G07C 5/08; E02F 9/24; E02F 9/26; B66C 15/06; G06F 3/16

(52) U.S. Cl. CPC B60Q 5/00; G05B 9/02; G06Q 50/265; G07C 5/02; G07C 5/085; B66F 17/006; E02F 9/26; B66C 15/065; G06F 3/167; G06F 3/165; E02F 9/24

(57) ABSTRACT

Safety communication system for heavy equipment comprising a voice input device in electrical communication with a processor, an input controller in electrical communication with the processor, a plurality of audio output devices in electrical communication with the processor, a data recorder in electrical communication with the processor, and a non-transitory memory having instructions that, in response to an execution by the processor, cause the processor to receive an audio communication from the voice input device, process the audio communication, record the audio communication on to the data recorder, and output the audio communication via the plurality of audio output devices are disclosed. Methods of conveying safety communication on a work site are also disclosed.

### CROSS-REFERENCE TO RELATED APPLICATION

This application claims priority to U.S. Provisional Patent Application Ser. No. 62/457,484, filed Feb. 10, 2017, the disclosure of which is hereby expressly incorporated by reference herein in its entirety.

### FIELD OF THE DISCLOSURE

This disclosure relates to safety communication systems and methods. More specifically, this disclosure relates to safety communication systems and methods for heavy equipment, such as construction and/or demolition equipment.

### BACKGROUND

According to one study, the total estimated costs of fatal and non-fatal occupational injuries and illnesses in heavy construction, except highway, in 2002 was estimated to be over $1.2 billion dollars. Geetha M. Waehrer, Costs of Occupational Injuries in Construction in the United States, 2007. Accordingly, to reduce the costs and risks associated with heavy construction, many of the largest construction companies in the United States have developed “360° walk-around” policies as part of best practices. Many of such policies require employees or contractors to walk completely around their heavy equipment prior to moving the heavy equipment. During the walk-around, the employee will look and endeavor to ensure that all equipment and materials are in the proper place and the areas beneath and surrounding the vehicle are clear and stable.

However, such policies are often difficult to comply with on a continual basis at a dynamic construction or demolition site. First, such policies require the driver to turn off the heavy construction equipment, unbuckle, put on safety equipment (e.g., a hard hat, safety glasses, etc.), dismount the vehicle, walk around the vehicle, get the attention of the other workers, communicate the message, reenter the vehicle, remove safety equipment, buckle-in, start the vehicle, and then proceed to move. This is often seen by employees as cumbersome, time-intensive, interruptive, and often redundant, especially for movement of short or limited distances.

Moreover, due to the dynamic nature of an active construction site, the safety of the location around the vehicle may change from when the driver doing the walk-around sees the local environment, reenters the vehicle, starts the vehicle, completes simple tasks (e.g., paperwork), and begins to move the vehicle.

Furthermore, as other workers move and work around heavy construction equipment, they may not be aware that the vehicle will shortly proceed to move. Thus, distracted workers can inadvertently be put in danger because they are unaware vehicles are proceeding to move. In some instances, this may lead to operators or other workers yelling back and forth, leading to contention between operators, workers, and/or management.

To ensure compliance, many construction companies have also instituted initial safety meetings prior to commencing construction activities for, during, and/or after the shift. During the safety meetings, safety procedures, hazards, and plans are reviewed. To reduce insurance costs, comply with industry best-practices, and comply with federal and local regulations, such activities must be documented. Such documentation can typically include: what was reviewed, what was said, those in attendance, the time of the meeting, the location of the meeting, and the duration of the meeting.

However, such documentation is very costly in lost productivity, increased administrative paperwork, and delay in communicating such information to administrative offices. Moreover, when multiple projects are done in a day, the assignment of costs to particular projects and/or tasks is often difficult or practically impossible. Also, what was actually covered in the meeting versus what was recorded as being discusses can often differ, which in some cases may lead to differing accounts when an accident is being investigated. Thus, a system that allows for quick, accurate, and comprehensive reporting of the meeting to the administrative offices is needed.

### SUMMARY

In some embodiments, safety communication systems for heavy equipment may include a voice input device in electrical communication with a processor, an input controller in electrical communication with the processor, a plurality of audio output devices in electrical communication with the processor, a data recorder in electrical communication with the processor, and a non-transitory memory having instructions that, in response to an execution by the processor, cause the processor to receive an audio communication from the voice input device, process the audio communication, record the audio communication on to the data recorder, and output the audio communication via the plurality of audio output devices.

Various embodiment of safety communication systems may also include embodiments where the processor is configured to record at the time the audio communication is received, at least one of a position of the heavy equipment, a task associated with the equipment, an operating condition of the equipment, a volume setting of the plurality of audio devices, an identity of an operator, a position of another vehicle, or combinations thereof.

In some embodiment at least one of the plurality of output devices are coupled to a functional member of the heavy equipment. The functional member may be selected from the group consisting of an arm, a beam, a belt, a blade, a conveyor, a chute, a platform, a trolley, a jib, a hoist, a lift cylinder, and a push frame. In some embodiment, least two audio output devices are coupled to the functional member. The at least two output devices are positioned to project the audio communication in different directions.

In some embodiment, an angle between the directions of the at least two output devices may be between about 10° to about 120°, between about 20° to about 60°, or may be about 30°.

In some embodiments, at least one of the plurality of output devices may be configured to couple to a counter-weight of the heavy equipment.

Also, sin some embodiments, at least one of the plurality of output devices is configured to couple to the front of a cab of the heavy equipment.

In some embodiments, the safety system may also include recording an operating condition of the heavy equipment selected from the group consisting of a speed of the heavy equipment, an acceleration of the heavy equipment, an orientation of a cab of the heavy equipment, an orientation of a functional member of the heavy equipment, a rate of fuel consumption, actuation of a brake of the heavy equipment, and a status of a battery of the heavy equipment.

A digital transmitter may also be included and may be configured to transmit at least one of the audio communication, a position of the heavy equipment, a task associated with the equipment, an operating condition of the equipment, a volume setting of the plurality of audio devices, an identity of an operator, a position of another vehicle, or combinations thereof.

Heavy equipment comprising the safety communication systems disclosed herein are also included within the scope of this disclosure. Examples of heavy equipment includes excavators, backhoe loaders, skid-steer loaders, forklifts, motor graders, crawler loaders, trenchers, scrapers, dump trucks, rollers, telehandlers, cranes, aerial lifts, scissor lifts, telescopic lifts, pavers, articulating trucks, draglines, drills, shotcreters, water trucks, and mixers.

Also disclosed herein are methods of conveying safety communication on a construction site comprising receiving an audio communication via a voice input device, processing the audio communication with a processor in electrical communication with the voice input device, recording the audio communication on a non-transitory memory in electrical communication with the processor, the non-transitory memory being coupled to to heavy equipment, and outputting the audio communication on a plurality of audio output devices, wherein the audio output devices are distally located from the voice input device and are coupled on the heavy equipment.

Various methods may also include transmitting, via a wireless transmitter configured to transmit data to a location removed from the heavy equipment, at least one of the audio communication, a position of the heavy equipment, a task associated with the equipment, an operating condition of the equipment, a volume setting of the plurality of audio devices, an identity of an operator, a position of another vehicle, or combinations thereof.

Also disclosed herein are safety communication system for heavy equipment comprising a voice input device in electrical communication with a processor, an input controller in electrical communication with the processor, a plurality of audio output devices in electrical communication with the processor, a data recorder in electrical communication with the processor, a non-transitory memory in electrical communication with the processor, and means for outputting the audio communication via the plurality of audio output devices.

Safety communication systems may also include means for transmitting the recorded audio communication to a location removed from the heavy equipment.

### BRIEF DESCRIPTION OF THE DRAWINGS

The above mentioned and other features and objects of this disclosure, and the manner of attaining them, will become more apparent and the disclosure itself will be better understood by reference to the following description of exemplary embodiments of the disclosure taken in conjunction with the accompanying drawings, wherein:

FIG. 1 shows a safety communication system according to various embodiments;

FIG. 2A is an illustrative side-view of an excavator including an embodiment of a safety communication system according to various embodiments;

FIG. 2B is another illustrative side-view of an excavator including an embodiment of a safety communication system according to various embodiments;

FIG. 2C is an illustrative rear-view of an excavator including an embodiment of a safety communication system according to various embodiments;

FIG. 2D is an illustrative front-view of an excavator with the boom, arm, and extended according to various embodiments;

FIG. 3 illustrates an input controller according to various embodiments;

FIG. 4A illustrates an aerial lift including an embodiment of a safety communication system according to various embodiments with the jib and boom extended; and

FIG. 4B illustrates the cage of an aerial lift having an embodiment of a safety communication system.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates exemplary embodiments of the disclosure, in various forms, and such exemplifications are not to be construed as limiting the scope of the disclosure in any manner.

### DETAILED DESCRIPTION

The embodiment disclosed below is not intended to be exhaustive or limit the disclosure to the precise form disclosed in the following detailed description. Rather, the embodiments are chosen and described so that others skilled in the art may utilize its teachings.

One of ordinary skill in the art will realize that the embodiments provided can be implemented in hardware, software, firmware, and/or a combination thereof. Programming code according to the embodiments can be implemented in any viable programming language such as C, C++, XTML, JAVA or any other viable high-level programming language, or a combination of a high-level programming language and a lower level programming language.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

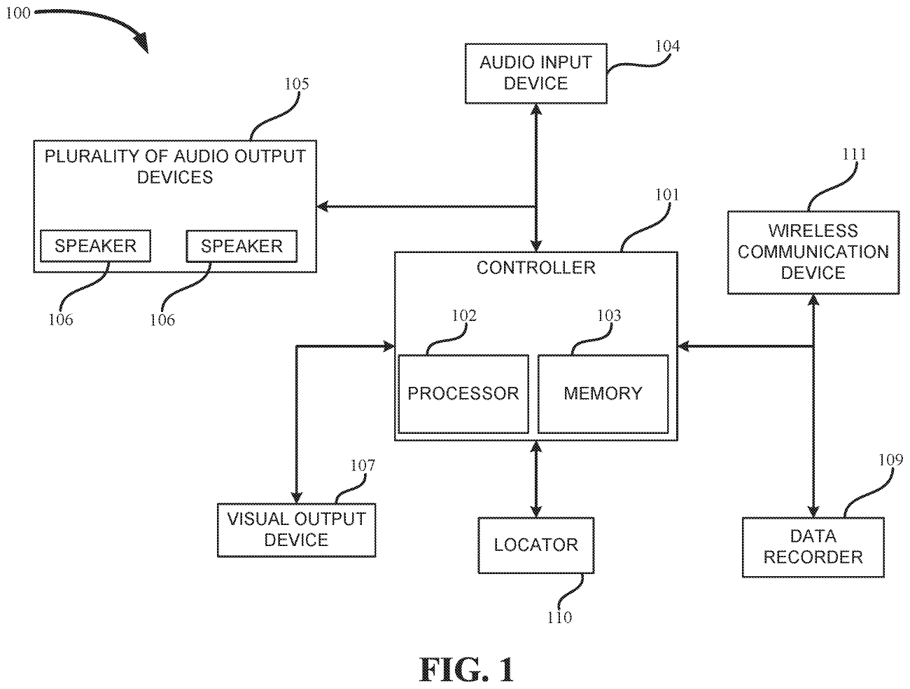

FIG. 1 illustrates an exemplary safety communication system according to various embodiments. Safety communication system 100 may comprise a controller 101 that may be in electrical communication with or include a processor 102 and non-transitory memory 103. In various embodiments controller 101 may be in electrical communication with a voice or audio input device 104.

Audio input device 104 is not particularly limited and may include a variety of microphones and audio input configurations. Exemplary audio input devices include handsets, headsets, wireless in-cab transmitters, wired in-cab transmitters, or other in-cab microphones, etc. In some embodiments, the audio input may be configured to reduce ambient noise and/or reduce echoing (i.e., echo suppression). In some embodiments, the audio input device 104 may be weather and water proof or resistant.

Controller 101 and/or processor 102 may be in electrical communication with a plurality of audio output devices 105. The plurality of audio output devices 105 may include two or more speakers 106. Data recorder 109 may also be in electrical communication with the controller 101 and/or processor 102.

Plurality of audio output devices 105 or speakers 106 is not particularly limited and may include any speaker known or hereinafter developed. Exemplary speakers include loud-speakers (e.g., such as with a public address system (PA system)), stereo speakers, etc. In various embodiments the speakers may be attached to the heavy equipment as an external after-market product. In other embodiments, the speakers may be integrated with the heavy equipment (e.g., an original equipment manufacturer (OEM) feature of the heavy equipment). In various embodiments, the speakers 106 may be water-proof and weather-proof or water and weather resistant.

In certain embodiments, the controller 101 includes one or more interpreters, determiners, evaluators, regulators, or processors, that functionally execute the operations of the controller 101. The description herein including interpreters, determiners, evaluators, regulators, and processors emphasizes the structural independence of certain aspects of the controller 101, and illustrates one grouping of operations and responsibilities of the controller. Other groupings that execute similar overall operations are understood within the scope of the present application. Interpreters, determiners, evaluators, regulators, and processors may be implemented in hardware and/or as computer instructions on a non-transient computer readable storage medium, and may be distributed across various hardware or computer based components.

Example and non-limiting implementation elements that functionally execute the operations of the controller include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

As used herein, the term “electrical communication” may include wired communication, wireless communication, or combinations thereof. In some embodiments, the safety communication system 100 may be configured to directly connect to existing electronics of heavy equipment. Thus, in various embodiments, the safety communication system 100 may be powered by the heavy equipment electronics. In various embodiments, this may include battery power from the heavy equipment's batteries (e.g., auxiliary batteries), alternators, or combinations thereof.

Thus, a person of ordinary skill in the art—with the benefit of this disclosure—will recognize that in some embodiments, the safety communication system 100 may be integrated with the existing electronics and controls of the heavy equipment. For example, the safety communication system 100 may be integrated or connected with the control area network (CAN) of the heavy equipment, which may use CAN protocol, such as that specified as International Standards Organization standard 11898. The communication network or bus may be a digital system that may use (or form) a single-wire, twisted pair wires, a two-wire connection, a three-wire connection, fiber optic connections or other suitable types of hardware and combinations thereof.

As used herein, the term “heavy equipment” may be understood to include heavy or large construction, mining, shipping, or demolition equipment. Exemplary heavy equipment may include excavators, backhoe loaders, skid-steer loaders, forklifts, motor graders, crawler loaders, trenchers, scrapers, dump trucks, rollers, telehandlers, cranes, aerial lifts (e.g., scissor lifts and telescopic lifts), pavers, articulating trucks, draglines, drills, shotcreters, water trucks, and mixers.

Non-transitory memory 103 may have instructions that, in response to an execution by the processor 102, cause the processor 102 to receive an audio communication from the voice or audio input device 104, process the audio communication, record the audio communication on to the data recorder 109, and output the audio communication via the plurality of audio output devices 105.

In various embodiments, safety communication system 100 may also include a locator 110, which may be configured to record the location of the heavy equipment. Furthermore, in some embodiments, controller 101 may be configured to record, at the time the audio communication is received, at least one of a position of the heavy equipment, a task associated with the equipment, an operating condition of the equipment, a volume setting of the plurality of audio devices, an identity of an operator, a position of another vehicle, or combinations thereof. Such data may be recorded and/or associated with each audio communication received from the audio input device 104.

The associated data is not particularly limited and may include recordings such as a speed of the heavy equipment, an acceleration of the heavy equipment, an engine condition of the heavy equipment, an orientation of a cab of the heavy equipment, an orientation of a functional member of the heavy equipment, a rate of fuel consumption, actuation of a brake of the heavy equipment, and a status of a battery of the heavy equipment.

Furthermore, controller 101 may be configured to communicate each recording of each audio communication and associated data. In some embodiments, this may be done by manually removing such associated data from safety communication system 100, by pulling the information remotely via wireless communication device 111, and/or by programming non-transitory memory 103 to automatically—either continuously for a preprogramed interval—send such recorded audio communication and/or associated data via the wireless communication device 111 to a remote location, such as a central or corporate office.

Wireless communication device 111 is not particularly limited and may include any wireless radio device known or hereinafter developed. Exemplary wireless communication devices include digital transmitters, radio links, Wi-Fi, satellite, Bluetooth, cellular technology, or combinations thereof. In various embodiments, the wireless communication device may be to transmit at least one of the audio communication, a position of the heavy equipment, a task associated with the equipment, an operating condition of the equipment, a volume setting of the plurality of audio devices, an identity of an operator, a position of another vehicle, or combinations thereof.

Communication safety system 100 may also include a visual output device 107, which may send a visual signal indicating the operation of the plurality of audio output devices 105, such as speakers 106. In various embodiments, visual output device 107 may allow for improved awareness of the use of safety communication system 100 in a work site. For example, visual output device 107 may increase worker's awareness of the audio communication being sent from safety communication system 100. Also, visual output device 107 may also increase other operators' awareness of the communication from the heavy equipment operating safety communication system 100. Thus, in the event another operator of a second piece of heavy equipment, does not hear the audio communication (e.g., commands or statements of intention) from the heavy equipment having safety communication system 100, the operator of the second piece of heavy equipment may be made aware that some movement is imminent or important communication is being conveyed. Thus, the operator of the second piece of heavy equipment may then use other communication systems (e.g., a radio) to communicate with the heavy equipment that has safety communication system 100.

Furthermore, in some applications, visual output device 107 may illustrate to managers, foreman, or other safety personnel that safety communication system 100 is being used, even though they may be too remote to hear the audio output of speakers 106.

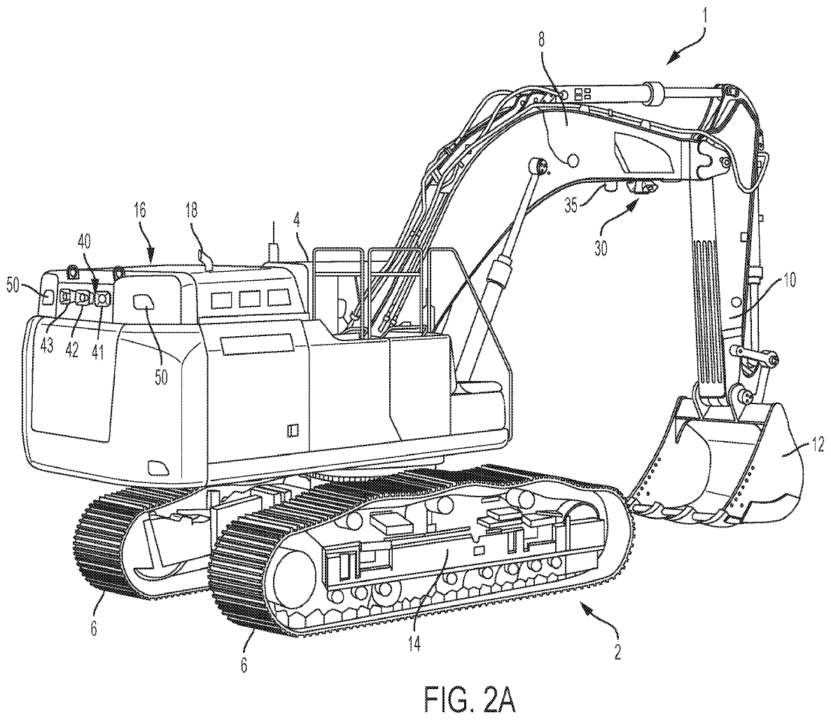

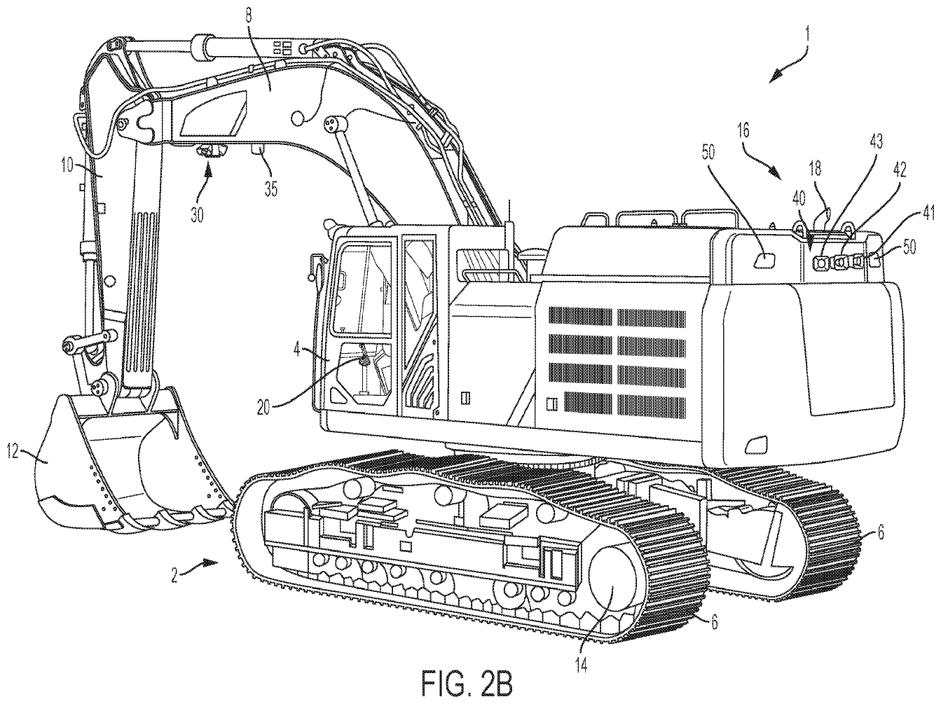

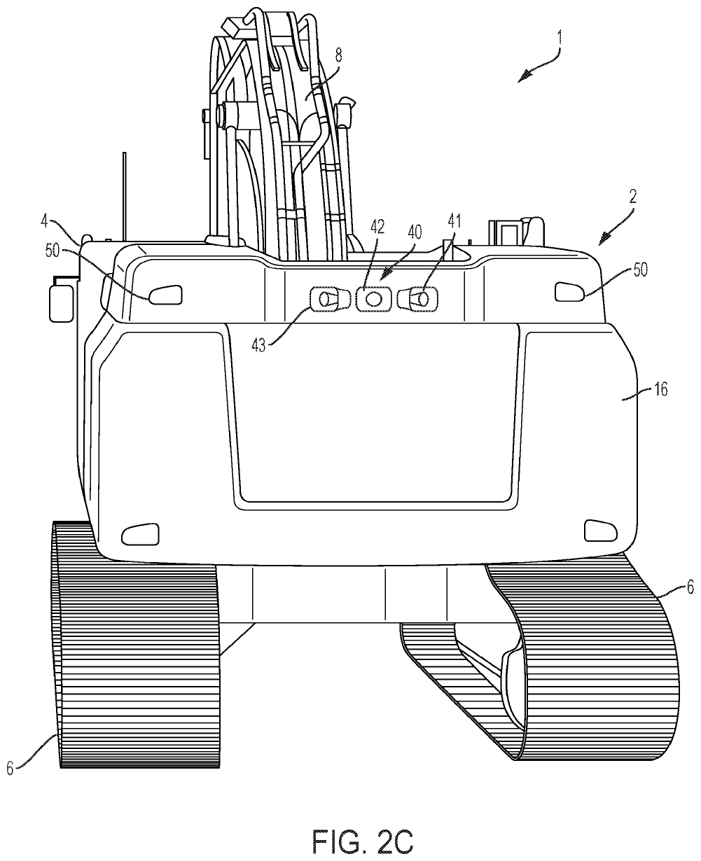

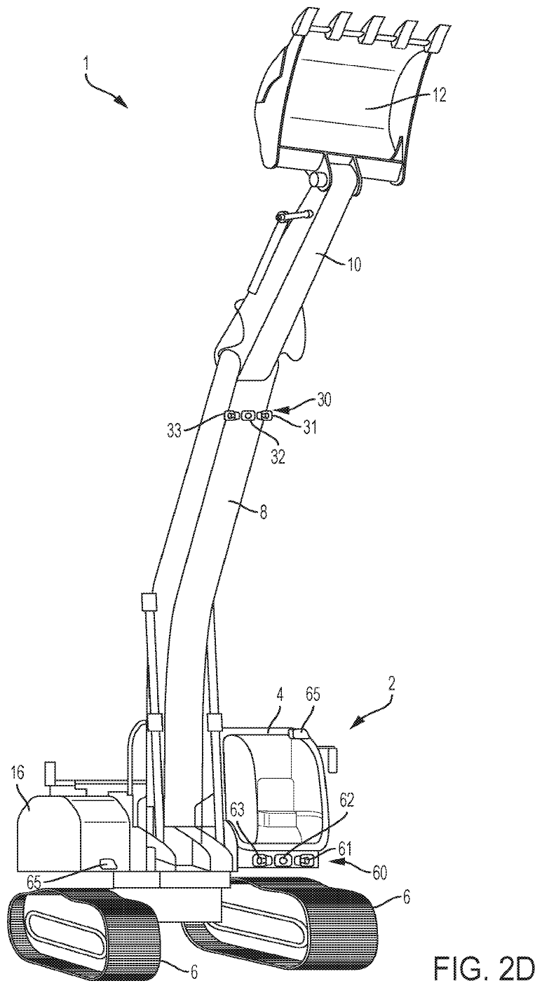

FIGS. 2A and 2B illustrate various side-views of an excavator having a safety communication system 1 for a piece of heavy construction equipment, such as excavator 2. Excavator 2 may include a plurality of ground engaging members, such as track assemblies 6. Excavator 2 may also include an engine 18 and counterweight 16 in communication with cab 4. Excavator may also include boom 8, which may be connected to arm 10 and bucket 12.

Exemplary excavator 2 is shown in FIGS. 2A and 2B with a rear plurality of audio output devices 40 and a plurality of audio output devices on a functional member 30. The rear plurality of audio output devices may include a first rear speaker 41, a second rear speaker 42, and a third rear speaker 43.

As shown in FIG. 2D, the plurality of audio output devices on a function member 30 may include a first functional member speaker 31, a second functional member speaker 32, and a third functional member speaker 33. Thus, in various embodiments, at least two output devices may be coupled to the functional member.

The functional member is not particularly limited and may include a functional member selected from the group consisting of an arm, a beam, a belt, a blade, a conveyor, a chute, a platform, a trolley, a jib, a hoist, a lift cylinder, a push frame, or combinations thereof. A person of ordinary skill will recognize—with the benefit of this disclosure—various optimal positions on the functional member depending on the function of the heavy equipment. For example, the positioning shown on excavator 2 in FIGS. 2A-2D, illustrates the plurality of audio output devices as being located on the boom. This may allow for the operator to control the direction of the audio output based on the orientation and/or function of the heavy equipment.

As used herein, the terms “coupling” or “coupled” may include a reversible coupling or irreversible coupling. Exemplary coupling methods include the use of magnets, adhesives, tape, nuts and bolts, screws, rivets, welding, clamps, and any other conventional method capable of securing the plurality of audio devices to the functional member when the heavy equipment is in operation.

Furthermore, with the benefit of this disclosure, a person of ordinary skill will recognize that the placement, orientation, and coupling of the output device(s) to the functional member may be altered based on the operation, configuration, and position of the functional member.

For example, with reference to FIGS. 2B and 2D, the position of the plurality of audio output devices on a function member 30 may be altered via operation of the functional member.

For example, the position of boom 8 in FIG. 2B may be used to communicate to workers in a ditch or hole. Similarly, boom 8 may be raised to the position shown in FIG. 2D to project the speakers to a location above the cab 4 or to project the audio communication a greater distance (e.g., during a preliminary safety meeting before beginning work on a job site).

Additionally, plurality of audio output devices 60 may be located on the front of the cab 4 of the heavy equipment. In various embodiments, the relative positioning of cab speakers 61, 62, and 63 may allow for audio and visual communication between the operator of the excavator 2 and other worksite personnel. For example, if the operator needs a signal that it was clear to move, the operator could position the cab 4 of the excavator 2 towards the personnel, could send an audio signal with safety communication system 1, and then could await visual confirmation from the personnel working in proximity to the excavator 2.

Furthermore, in some embodiments, forward lights 65 may be used to attract the attention of workers when the safety communication system 1 is activated and the audio signal is sent via plurality of audio output devices 30 and/or plurality of audio output devices 60.

Similarly, with reference to FIG. 2B, rear visual output signal system 50 may be used when rear plurality of audio output devices 40 are used. In various embodiments, such as illustrated in FIG. 2B the audio output devices, such as speakers 41, 42, and 43, may be coupled to or be configured to couple to the counter weight 16, which in some embodiments, may house engine 18 of the heavy equipment.

Furthermore, the front of excavator 2 may include a front plurality of audio output devices, which may include first forward speaker 61, second forward speaker 62, and third forward speaker 63.

The relative positions of the various audio output devices both between at least two pluralities of audio output devices and/or within a plurality of audio output devices is not particularly limited. In various embodiments, depending on the nature, function, and operation of the heavy equipment, the position of each speaker and/or pluralities of output devices may be optimized to alert nearby personnel of communication from the operator of the safety communication system.

As shown in FIGS. 2A-2D, the speakers or output devices may be positioned to project the audio communication in different directions. This may be between pluralities of audio output devices or within a single plurality of output devices. For example, FIG. 2D illustrates first front speaker 61, second front speaker 62, and third front speaker 63 projecting in three separate directions relative to cab 4.

The angle between the projection direction is not particularly limited and, in various embodiments, may vary. The angle between the two devices may be understood to be the angle between the center of the projection directions of the two audio output devices. In various embodiments, the angle between the directions of the at least two output devices may be between about 10° to about 120°, between about 10° to about 90°, between about 10° to about 60°, may be between about 20° to about 45°, or may be about 30°.

In various embodiments, safety communication system may include a data recorder 109 in electrical communication with the processor 102, and a non-transitory memory 103 having instructions that, in response to an execution by the processor, cause the processor to receive an audio communication from the voice input device, process the audio communication, record the audio communication on to the data recorder 109, and output the audio communication via the plurality of audio output devices 105. The data recorder is not particularly limited and may include any conventional data recorder capable of storing the audio communication and/or associated data with the audio communication. Such recorders often include non-transitory and/or non-volatile memory configured to store the communications when the heavy equipment is turned off. In some embodiments, such recorders may include a separate power source, such as a battery, or in other embodiments, they may be electrically connected to the power sources of the heavy equipment.

To facilitate transmission of the audio signal while operating the heavy equipment, the audio input device 104, such as a microphone, may be electronically coupled to a switch or controller 20. In various embodiments, the controller may be separate from the controls of the heavy equipment, may be attached to the controls of the heavy equipment, or may be integrated with the controls of the heavy equipment.

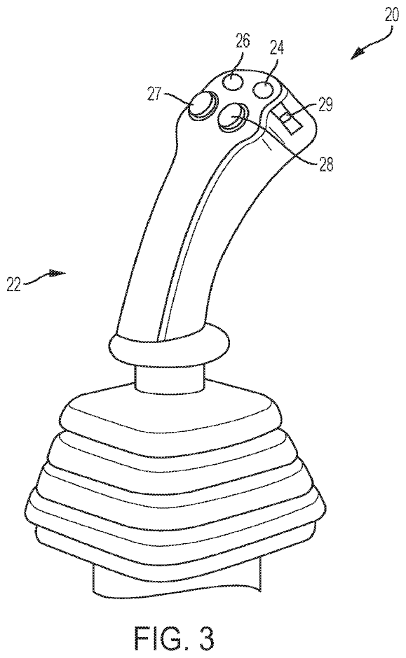

For example, FIG. 3 illustrates excavator control or joystick 22 having excavator controls 27 and 28 with integrated safety communication system controller 20. Integrated safety communication system controller 20 may include audio control 26, visual control 24, and/or audio output volume control 29.

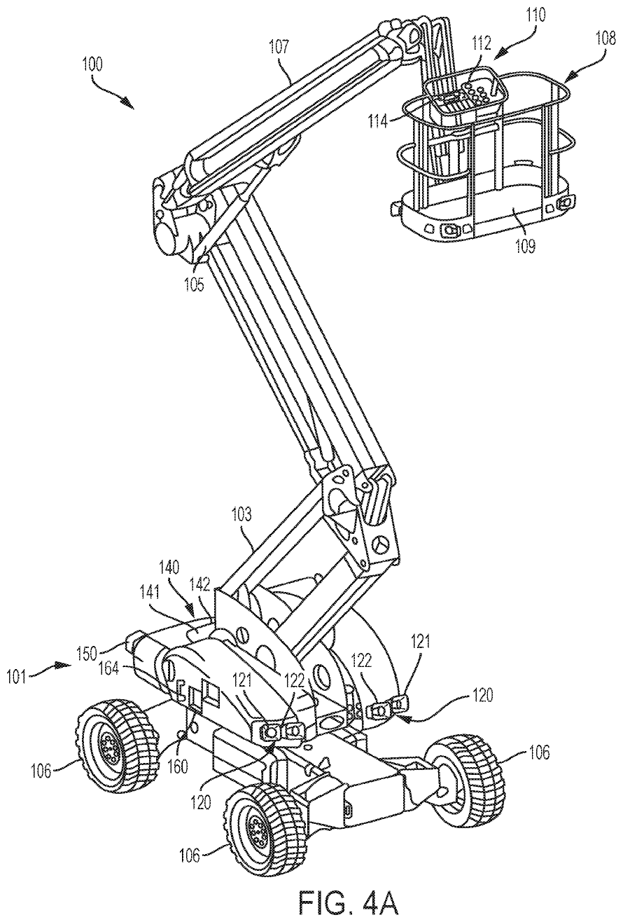

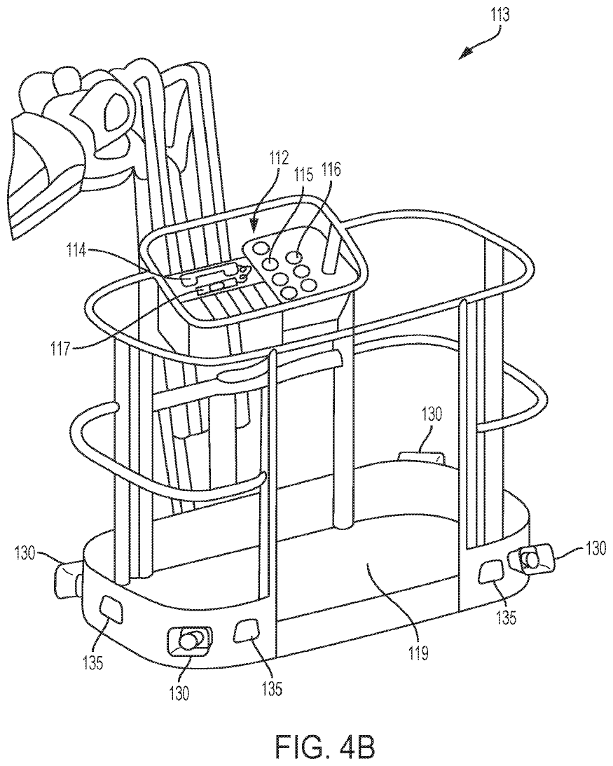

FIGS. 4A and 4B illustrate another embodiment where a plurality of audio output devices on a functional member 130 are illustrated. In FIGS. 4A and 4B, the plurality of audio output devices may be connected to the cage/platform 119 on an aerial lift 101. In some embodiments, cage may include one or more visual output devices 135.

Cage/platform 119 may also include upper controls 112, which may include an audio/voice input device, such as receiver 114. The volume of the plurality of speakers may be controlled by volume control 117 or may be automatically controlled by the processor 102 and/or controller 101. In some embodiments, receiver may be configured to automatically begin receiving and/or recording when the receiver 114 is picked up, or, may be controlled by audio control 115. Similarly, in some embodiments, visual control 116 may be configured to activate visual output devices 135, visual output devices 135 may automatically activate upon activation of the audio control 115, and/or visual output devices 135 may automatically activate upon picking up second receiver 114.

In some embodiments, safety communication systems such as safety communication system 100 in FIG. 4A, may include a second audio input device, such as second receiver 164, which may be controlled by control panel 160. As shown with aerial lift 101 in FIG. 4A, a second receiver 114 or second audio/voice input device may allow for communication from or to another distal end of the aerial lift 101, when the boom riser 103 and the boom lift mast 107 are extended.

For example, when crews are working in or near the extended cage/platform 119, they may be able to receive communication from personnel near the ground engaging members 106 of aerial lift 101.

Similarly, crews working in the extended cage/platform 119 may be able to communicate with ground crews with either the plurality of audio output devices 130, 120, and/or 140. For example, if a safety hazard is needed to be broadcast over a large area, audio output devices 130 may be used to output the audio communication. If the crew in the extended platform need to move the machine or need to communicate to the ground crew near the base of aerial lift 101, then various combinations of the plurality of audio output devices 120 and 140 may be used, or all speakers may be used.

For example, in some embodiments, speakers 121 and 122 may be used before moving the aerial lift forwards and, if the aerial lift is being reversed, then speakers 141 and 142 may be used. Thus, also disclosed herein are safety communication systems for heavy equipment comprising a voice input device in electrical communication with a processor, an input controller in electrical communication with the processor, a plurality of audio output devices in electrical communication with the processor, a data recorder in electrical communication with the processor, and means for receiving an audio communication from the voice input device, means for processing the audio communication, means for recording the audio communication on to the data recorder, and means for outputting the audio communication via the plurality of audio output devices.

In some embodiments, the safety communication system may include means for transmitting the recorded audio communication to a location removed from the heavy equipment.

Also disclosed herein are methods of conveying safety communication on a work site, such as a construction site. Such methods may include receiving an audio communication via a voice input device, processing the audio communication with a processor in electrical communication with the voice input device, recording the audio communication on a non-transitory memory in electrical communication with the processor, outputting the audio communication on a plurality of audio output devices distally located from the voice input device on a heavy equipment. In some embodiments, methods of conveying safety communication on a work site may also include transmitting, via a digital transmitter configured to transmit data to a location removed from the heavy equipment, at least one of the audio communication, a position of the heavy equipment, a task associated with the equipment, an operating condition of the equipment, a volume setting of the plurality of audio devices, an identity of an operator, a position of another vehicle, or combinations thereof.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A safety communication system for heavy equipment comprising:
a voice input device in electrical communication with a processor;
an input controller in electrical communication with the processor;
a plurality of audio output devices in electrical communication with the processor;
a data recorder in electrical communication with the processor; and
a non-transitory memory having instructions that, in response to an execution by the processor, cause the processor to
receive a live audio communication from the voice input device,
process the live audio communication,
record the live audio communication on to the data recorder, and
output the live audio communication via the plurality of audio output devices.

2. The safety communication system of claim 1, wherein the processor is configured to record at the time the audio communication is received, at least one of a position of the heavy equipment, a task associated with the equipment, an operating condition of the equipment, a volume setting of the plurality of audio devices, an identity of an operator, a position of another vehicle, or combinations thereof.

3. The safety communication system of claim 1, wherein at least one of the plurality of output devices are coupled to a functional member of the heavy equipment.

4. The safety communication system of claim 3, wherein the functional member is selected from the group consisting of an aim, a beam, a belt, a blade, a conveyor, a chute, a platform, a trolley, a jib, a hoist, a lift cylinder, and a push frame.

5. The safety communication system of claim 4, wherein at least two output devices are coupled to the functional member.

6. The safety communication system of claim 5, wherein the at least two output devices are positioned to project the audio communication in different directions.

7. The safety communication system of claim 6, wherein an angle between the directions of the at least two output devices is between about 10° to about 120°.

8. The safety communication system of claim 7, wherein the angle is between about 20° to about 60°.

9. The safety communication system of claim 8, wherein the angle is about 30°.

10. The safety communication system of claim 1, wherein at least one of the plurality of output devices is configured to couple to a counter-weight of the heavy equipment.

11. The safety communication system of claim 1, wherein at least one of the plurality of output devices is configured to couple to the front of a cab of the heavy equipment.

12. The safety communication system of claim 1, further comprising recording an operating condition of the heavy equipment selected from the group consisting of a speed of the heavy equipment, an acceleration of the heavy equipment, an orientation of a cab of the heavy equipment, an orientation of a functional member of the heavy equipment, a rate of fuel consumption, actuation of a brake of the heavy equipment, and a status of a battery of the heavy equipment.

13. The safety communication system of claim 1, further comprising a digital transmitter configured to transmit at least one of the audio communication, a position of the heavy equipment, a task associated with the equipment, an operating condition of the equipment, a volume setting of the plurality of audio devices, an identity of an operator, a position of another vehicle, or combinations thereof.

14. The safety communication system of claim 1, further comprising a second voice input device.

15. Heavy equipment comprising the safety communication system of claim 1.

16. The heavy equipment of claim 11, wherein the heavy equipment is selected from the group consisting of excavators, backhoe loaders, skid-steer loaders, forklifts, motor graders, crawler loaders, trenchers, scrapers, dump trucks, rollers, telehandlers, cranes, aerial lifts, scissor lifts, telescopic lifts, pavers, articulating trucks, draglines, drills, shotcreters, water trucks, and mixers.

17. A method of conveying safety communication on a construction site comprising:
receiving an audio communication via a voice input device;
processing the audio communication with a processor in electrical communication with the voice input device;
recording the audio communication on a non-transitory memory in electrical communication with the processor, the non-transitory memory being coupled to heavy equipment;
wherein the processor is configured to record at the time the audio communication is received, at least one of a position of the heavy equipment, a task associated with the equipment, an operating condition of the equipment, a volume setting of the plurality of audio devices, an identity of an operator, a position of another vehicle, or combinations thereof, and
outputting the audio communication on a plurality of audio output devices, wherein the audio output devices are distally located from the voice input device and are coupled on the heavy equipment.

18. The method of claim 17, further comprising transmitting, via a wireless transmitter configured to transmit data to a location removed from the heavy equipment, at least one of the audio communication, a position of the heavy equipment, a task associated with the equipment, an operating condition of the equipment, a volume setting of the plurality of audio devices, an identity of an operator, a position of another vehicle, or combinations thereof.

19. A safety communication system for heavy equipment comprising:
a voice input device in electrical communication with a processor;
an input controller in electrical communication with the processor;
a plurality of audio output devices in electrical communication with the processor;
a data recorder in electrical communication with the processor;
a non-transitory memory in electrical communication with the processor; and
means for outputting a live audio communication via the plurality of audio output devices;
wherein the live audio communication is received from the voice input device and recorded to the non-transitory memory.

20. The safety communication system of claim 19, further comprising means for transmitting the recorded audio communication to a location removed from the heavy equipment.
